(19) United States
(12) Patent Application Publication
(10) Pub. No.: US 2013/0082564 A1
(43) Pub. Date: Apr. 4, 2013

(54) ALTERNATOR FOR VEHICLE

(71) Applicants: Yoshihisa Ishikawa, Hadano (JP); Kenji Miyata, Hitachinaka (JP); Takayuki Koyama, Hitachi (JP)

(72) Inventors: Yoshihisa Ishikawa, Hadano (JP); Kenji Miyata, Hitachinaka (JP); Takayuki Koyama, Hitachi (JP)

(73) Assignee: HITACHI, LTD., Tokyo (JP)

(21) Appl. No.: 13/697,424

(22) PCT Filed: May 31, 2010
(86) PCT No.: PCT/JP2010/059200

§ 371 Date: Nov. 12, 2012

(51) Int. Cl. H02K 1/22

(52) U.S. Cl. CPC H02K 1/22
USPC 310/263

(57) ABSTRACT

An alternator for a vehicle includes: a rundel-type rotor including a cylindrical portion around which a field coil is wound, a pair of plate-shaped end plate portions which are arranged such that the end plate portions face both end surfaces of the cylindrical portion in the axial direction in an opposed manner, first claw portions which extend parallel to a rotary axis from one end plate portion, and second claw portions which extend parallel to the rotary axis from the other end plate portion, and a stator which is arranged on an outer peripheral side of the rotor with a rotary gap therebetween so as to face the rotor in an opposed manner, and has a laminated core on which an armature coil is wound. The between claw magnetic poles of the first and second claw portions is set to a optimum gap range to maximize output current.

### TECHNICAL FIELD

The present invention relates to an alternator for a vehicle which is mounted on a passenger automobile, a truck or the like.

### BACKGROUND ART

Recently, an alternator for an automobile is required to satisfy a demand for the miniaturization and the enhancement of power generating ability while keeping the same frame. That is, there has been a demand for providing a miniaturized high-output alternator for a vehicle at a reasonable cost.

An alternator for a vehicle described in patent document includes a rotor having a rundel-type core which is constituted of a cylindrical portion, a yoke portion, and claw-shaped magnetic pole portions. This patent document 1 proposes the alternator for an automobile where a length of a stator core in the axial direction is set larger than a length of the cylindrical portion of the rotor in the axial direction, and a cross-sectional area of a root of the claw-shaped magnetic pole portion is set narrower than an area of the cylindrical portion and a cross-sectional area of the yoke portion. Due to such a constitution, a portion of a magnetic flux directly flows into the stator core from the yoke, and a coil cross section of a field coil is ensured by decreasing a cross-sectional area of roots of the claw-shaped magnetic pole portions.

### CITATION LIST

### Patent Literature

PTL 1: Japanese patent publication 3381608

### SUMMARY OF INVENTION

### Technical Problem

However, in making the cross-sectional area of roots of the claw-shaped magnetic pole portions narrower than an area of the cylindrical portion and a cross-sectional area of the yoke portion as in case of the rotor core described in the above-mentioned patent document 1, it is necessary to study such decrease of the cross-sectional area in more detail by taking into account the magnetic saturation in the vicinity of the roots of the claw-shaped magnetic pole portions. For example, when the cross-sectional area of roots of the claw-shaped magnetic pole portions is excessively small, the magnetic resistance is increased and is saturated at the roots of the claw-shaped magnetic pole portions so that it is difficult to enhance an output current to an expected level.

In this manner, the way how to enhance an output current has been the task that an alternator for a vehicle has to achieve. Under such circumstances, it is an object of the present invention to achieve the further enhancement of performance of an alternator for a vehicle having a rundel-type rotor by improving a shape of a rotor core.

### Solution to Problem

To overcome the above-mentioned drawbacks, one desirable aspect of the present invention is as follows.

In an alternator for a vehicle which includes: a rundel-type rotor which includes a cylindrical portion around which a field coil is wound, first and second plate-shaped end plate portions which are arranged such that the end plate portions face both end surfaces of the cylindrical portion in the axial direction in an opposed manner, a plurality of first claw portions which extend parallel to a rotary axis in the direction from the first end plate portion to the second end plate portion, and a plurality of second claw portions which extend parallel to the rotary axis in the direction from the second end plate portion to the first end plate portion, and are arranged alternately in the circumferential direction with respect to the plurality of first claw portions; and a stator which is arranged on an outer peripheral side of the rundel-type rotor with a rotary gap therebetween so as to face the rundel-type rotor in an opposed manner, and has a laminated core on which an armature coil is wound, a size of a gap between a claw magnetic pole of the first claw portion and a claw magnetic pole of the second claw portion which are arranged adjacent to each other is set to a value which falls within a predetermined optimum gap range including a size of the gap between the claw magnetic poles where an output current becomes maximum.

### Advantageous Effects of Invention

According to the present invention, the further enhancement of an output current of an alternator for a vehicle can be realized.

### BRIEF DESCRIPTION OF DRAWINGS

FIG. 1 is a cross-sectional view showing the constitution of an alternator for a vehicle 100.

FIG. 2 is a perspective view showing an external appearance of a rotor 112.

FIG. 3 is a cross-sectional view of the rotor 112.

FIG. 4 is a view showing the constitution of a rectifying circuit 11.

FIG. 5 is a view for explaining an equivalent magnetic circuit.

FIG. 6 is a view showing a shape of an outer peripheral surface of a claw portion 112c.

FIG. 7 is a view for explaining magnetic resistance r20 and magnetic resistance r21.

FIG. 8 is a view for explaining a shape of the claw portion 112c.

FIG. 9 is a view showing a shape of a claw portion in a φ128 alternator (12 poles) and a result of simulation.

FIG. 10 is a view showing shapes of claw portions S1, S2, S3 and S4.

FIG. 11 is a view showing a result of simulation of a φ128 alternator (12 poles).

FIG. 12 is a view showing a result of simulation of a φ139 alternator (12 poles).

FIG. 13 is a view showing a result of simulation of a φ128 alternator (16 poles).

FIG. 14 is a view showing a result of simulation of a φ139 alternator (16 poles).

FIG. 15 is a view showing a shape of an outer peripheral surface of the claw portion 112c when R rounding is applied to the claw portion 112c.

### DESCRIPTION OF EMBODIMENTS

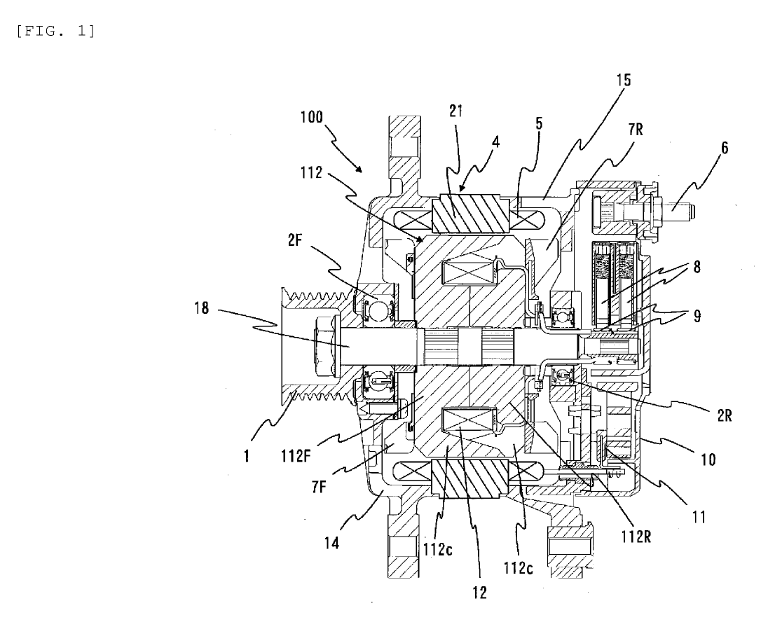

Hereinafter, the best mode for carrying out the present invention is explained in conjunction with drawings. FIG. 1 is a view showing one embodiment of the present invention, and is a cross-sectional view showing the constitution of an alternator 100 for a vehicle. A pulley 1 is mounted on a distal end of a shaft 18 on which a rotor 112 is mounted, and a belt is wound around and is extended between the pulley 1 and a pulley which is mounted on a drive shaft of an engine not shown in the drawing. The shaft 18 is rotatably supported by a bearing 2F which is mounted on a front bracket 14 and a bearing 2R which is mounted on a rear bracket 15. A stator 4 which is arranged to face the rotor 112 in an opposed manner with a slight gap therebetween is held in a state where the stator 4 is sandwiched between the front bracket 14 and the rear bracket 15.

Slip rings 9 for supplying electricity to a field coil 12 are mounted on a rear end of the shaft 18. Both ends of a coil conductor which constitutes the field coil 12 extend along the shaft 18 and are connected to the slip rings 9 respectively. Electricity for generating a magnetic field is supplied to the field coil 12 from a battery mounted on the vehicle via brushes 8 which are brought into contact with the slip rings 9.

A front fan 7F and a rear fan 7R each having a plurality of blades on an outer peripheral side thereof are mounted on both front and rear end surfaces of the rotor 112 in the rotary axis direction. These fans 7F, 7R are integrally rotated with the rotor 112, and circulate air from an inner peripheral side to an outer peripheral side. Here, the front-bracket-14-side front fan 7F has blades smaller than blades of the rear-bracket-15-side rear fan 7R, and a flow rate of air which the front fan 7F can circulate is smaller than a flow rate of air which the rear fan 7R can circulate.

The stator 4 is constituted of a stator core 21 and a stator winding 5, and is arranged to face the rotor 112 in an opposed manner with a slight gap therebetween. The stator core 21 is held in a state where the stator core 21 is sandwiched between the front bracket 14 and the rear bracket 15 from front and rear sides. The stator winding 5 is constituted of three-phase windings, and lead wires of the respective windings are connected to a rectifying circuit 11. The rectifying circuit 11 is constituted of a rectifying element such as a diode, and constitutes a full-wave rectifying circuit. For example, when a diode is used as the rectifying element, a cathode terminal of the diode is connected to a terminal 6, and an anode-side terminal is electrically connected to a body of the alternator for a vehicle. Here, a rear cover 10 in which an air hole is formed for cooling plays a role of a protection cover for the rectifying circuit 11.

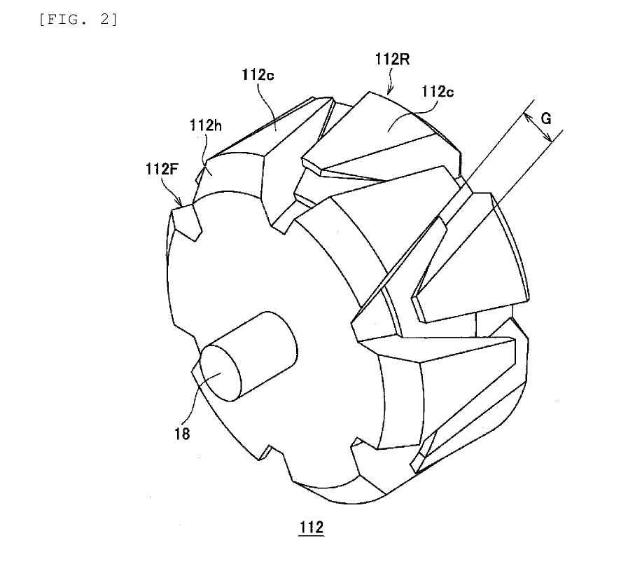

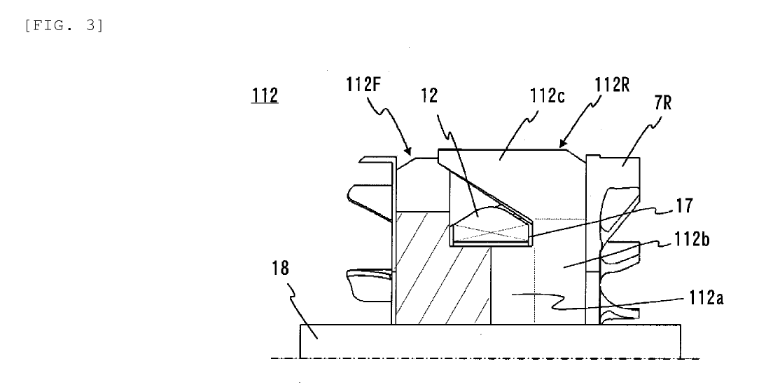

FIG. 2 and FIG. 3 are views showing the rotor 112. FIG. 2 is a perspective view showing an external appearance of the rotor 112, and FIG. 3 is a view showing the rotor 112 on an upper side of a center axis of the shaft 18 in cross section. As shown in FIG. 3, the rotor 112 of this embodiment constitutes a rundel-type rotor (claw-magnetic-pole type rotor). Rotor cores 112F, 112R which are formed using a magnetic material are respectively joined to an approximately center portion of the shaft 18 in the rotary axis direction by serration fitting so that the rotor cores 112F, 112R are integrally rotated with the shaft 18. The rotor core 112F on a front side and the rotor core 112R on a rear side are mounted on the shaft 18 in a state where cylindrical portions 112a of the rotor cores 112F, 112R are brought into contact with each other in an opposedly facing manner, and the movement of the respective rotor cores 112F, 112R in the axial direction is restricted by allowing outer ends of the respective rotor cores 112F, 112R to plastically flow in annular grooves formed on the shaft 18. The rotor core 112R and the rotor core 112F have the same shape.

Each of the rotor cores 112F, 112R has the cylindrical portion 112a around which the field coil 12 is wound, an end plate portion 112b which is perpendicular to the rotary axis, and a plurality of claw portions 112c which are formed on an outer-peripheral-side end surface of the end plate portion 112b and extend parallel to the rotary axis. As shown in FIG. 2, the claw portions 112c of the rotor core 112F and the claw portions 112c of the rotor core 112R are arranged alternately in the circumferential direction, and a gap G formed between the claw portions 112c arranged adjacent to each other is referred to as a gap size between claw magnetic poles. Here, the gap size G between claw magnetic poles indicates a distance between an edge of an outermost peripheral surface of the claw portion 112c and an edge of an outermost peripheral surface of the claw portion 112c arranged adjacent to the former claw portion 112c. In this embodiment, six claw portions 112c are formed on the rotor cores 112F, 112R respectively, and the number of poles of the rotor 112 is set to 12 poles.

As shown in FIG. 3, the rotor cores 112F, 112R are mounted on the shaft 18 in a state where the cylindrical portions 112a of the respective rotor cores 112F, 112R face each other in an opposed manner. The claw portions 112c which are formed on the end plate portion 112b of each rotor core 112F, 112R extend in the direction toward the other rotor core. The claw portions 112c of the rotor core 112F and the claw portions 112c of the rotor core 112R are arranged alternately in the circumference direction of the rotor.

The field coil 12 which is wound around a coil bobbin 17 is arranged between outer peripheries of the cylindrical portions 112a and inner peripheries of the claw portions 112c. The coil bobbin 17 is fitted on the cylindrical portions 112a of the rotor cores 112F, 112R, and the field coil 12 is wound around a barrel portion of the coil bobbin 17 about the rotary axis. The insulation of the field coil 12 is ensured by the coil bobbin 17 which is interposed between the rotor cores 112F, 112R and the field coil 12.

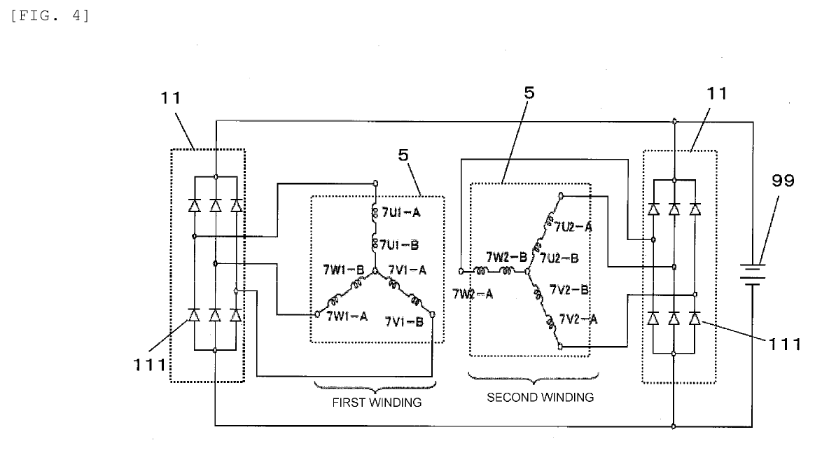

FIG. 4 is a view showing the constitution of the rectifying circuit 11. In the alternator for a vehicle of this embodiment, the stator winding 5 includes a first winding and a second winding with their phases shifted by 30 degrees. The rectifying circuit 11 which performs the three-phase full-wave rectification is provided to each winding. Each rectifying circuit 11 is constituted by connecting three sets of series circuits each of which is constituted of two diodes 111 in parallel.

Stator windings 5 of a U phase, a V phase and a W phase are connected to each other by the three-phase Y-connection, and terminals of the stator windings 5 on a side opposite to neutral point side of the stator windings 5 are connected to joints of the diodes 111 which are connected in series. The upper-side (plus-side) diodes 111 have a common cathode, and the common cathode is connected to a plus terminal of a battery 99. Anodes of the lower-side (minus-side) diodes 111 are connected to a minus terminal of the battery 99.

In this embodiment, although the explanation is made by taking the double-star winding shown in FIG. 4 as an example, the present invention is also applicable to windings other than the double-star winding such as single-star winding, single-delta winding, or double-delta winding, for example, in the same manner as the double-star winding.

Next, the explanation is made with respect to the power generating operation. As described above, the pulley 1 and the engine-side pulley are connected to each other by the belt, and the rotor 112 is rotated along with the rotation of the engine. The rotor 112 is magnetized when an electric current flows through the field coil 12 so that a magnetic path which goes around the periphery of the field coil 12 is formed in the rotor 112. On the other hand, a magnetic flux which is emitted from the claw portions 112c of one rotor core enters the stator core 21 and, thereafter, enters the claw portions 112c of the other rotor core. Then, when the rotor 112 is rotated, a rotating magnetic field is formed thus generating a three-phase induced electromotive force in the stator windings 5. The full-wave rectification is applied to a voltage of the three-phase induced electromotive force by the above-mentioned rectifying circuit 11 so that a DC voltage is generated. A plus side of the DC voltage is connected to the terminal 6 and is further connected to the battery 99.

Although the detailed explanation is omitted, a field current which is supplied to the field coil 12 is controlled such that a DC voltage immediately after the rectification becomes a voltage suitable for charging the battery 99 and, further, is controlled corresponding to a state of the battery 99 such that the charging is started when a power generation voltage becomes higher than a battery voltage of the vehicle. An IC regulator (not shown in the drawing) which is provided as a voltage control circuit for adjusting a power generation voltage is arranged in the inside of the rear cover 10 shown in FIG. 1, and performs a control such that a terminal voltage of the terminal 6 always takes a constant voltage.

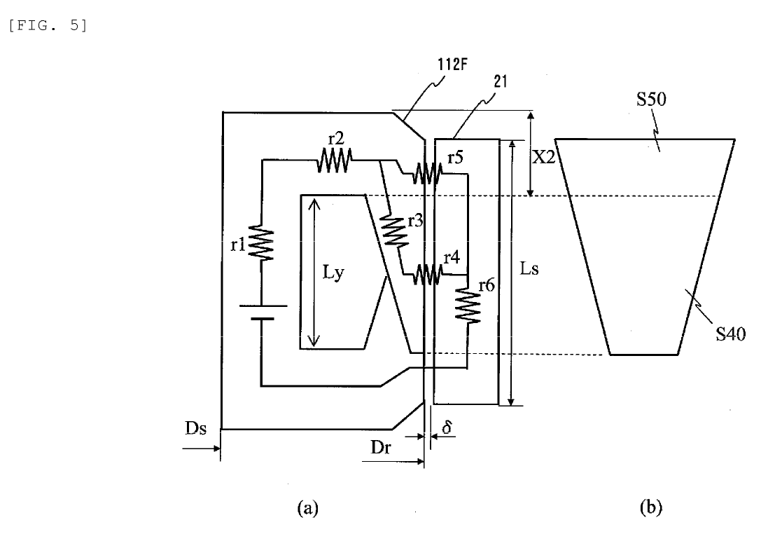

FIG. 5(a) is a view showing an equivalent magnetic circuit of this embodiment, and FIG. 5(b) is a view showing a region of an outer peripheral surface of the claw portion 112c which faces the stator core 21 in an opposed manner. Although the claw portion 112c is provided in a state that the claw portion 112c is connected to the outer periphery of the end plate portion 112b, in this embodiment, a stator-core opposedly facing surface region of the claw portion 112c at such a connection portion is indicated by symbol S50, and a stator-core opposedly facing surface region of the claw portion 112c at other portions is indicated by symbol S40. That is, a region which is the sum of the region indicated by symbol S40 and the region indicated by symbol S50 forms the stator-core opposedly facing surface region of the claw portion 112c.

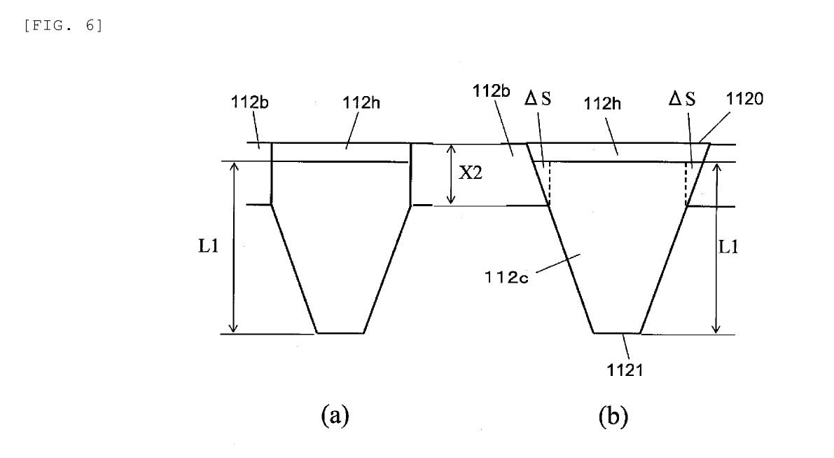

FIG. 6 is a view showing the configuration of a prior art and the configuration of this embodiment in comparison with respect to a shape of the claw portion 112c as viewed from a stator side (in this embodiment, this shape being referred to as an “outer peripheral surface shape”). FIG. 6(b) is a view showing the outer peripheral surface shape of the claw portion 112c of this embodiment, and is a plan view of the claw portion 112c as viewed from a stator side. The outer peripheral surface shape of the claw portion 112c is tapered to a distal end 1121 of the claw portion 112c from an end-plate-side end 1120 of the claw portion 112c in the extending direction of the claw portion 112c. That is, a width size of the claw portion 112c in the circumferential direction in cross section perpendicular to the extending direction of the claw portion 112c is set such that the width size of the claw portion 112c is gradually decreased from the end-plate-side end 1120 to the distal end 1121 of the claw portion 112c. In other words, the width size of the claw portion 112c is set to be increased as a root portion of the claw portion 112c approaches the end-plate-side end portion 1120. Accordingly, in a plan view shown in FIG. 6(b), the outer peripheral surface shape of the claw portion 112c forms a trapezoidal shape. Here, an outer peripheral surface of a portion indicated by a size L1 in the extending direction of the claw portion is a portion which faces the stator core 21 in an opposed manner, that is, the above-mentioned stator-core opposedly facing surface region. A portion indicated by symbol 112h is a chamfered portion.

On the other hand, an outer peripheral surface shape of a claw magnetic pole of a conventional rundel-type rotor has a shape as shown in FIG. 6(a). That is, the outer peripheral surface shape of the claw magnetic pole is formed such that portions where the claw portion 112c and the end plate portion 112b are connected to each other are arranged parallel to the rotary axis. Accordingly, the stator-core opposedly facing surface region (hereinafter referred to as “claw magnetic pole surface area”) of the claw portion 112c shown in FIG. 6(b) is larger than the claw magnetic pole surface area of the claw portion 112c shown in FIG. 6(a) by an amount corresponding to 2ΔS in the portions where the claw portion 112c and the end plate portion 112b are connected to each other.

In the equivalent magnetic circuit shown in FIG. 5(a), assume magnetic resistance of the cylindrical portion 112a as r1. Also assume magnetic resistance of a portion including the end plate portion 112b and a root region of the claw portion 112c which is connected to the end plate portion 112b as r2, and assume magnetic resistance of a portion of the claw portion 112c which projects more inwardly than the end plate portion 112b as r3. Further, assume magnetic resistance of a gap formed between the region S40 of the claw portion 112c and the stator core 21 as r4, and assume magnetic resistance of a gap formed between the region S50 of the claw portion 112c and the stator core 21 as r5. Still further, symbol r6 indicates magnetic resistance of the stator core 21. In this manner, a magnetic flux which enters the stator core 21 from the claw portion 112c is considered by dividing the magnetic flux into a magnetic flux which enters the stator core 21 through the region S40 and a magnetic flux which enters the stator core 21 through the region S50.

As can be understood from FIG. 5(a), combined magnetic resistance r345 of the magnetic circuit ranging from the end plate portion 112b to the stator core 21, that is, combined magnetic resistance r345 between magnetic resistance r2 and magnetic resistance r6 is expressed by a following formula (1) using magnetic resistances r3, r4, r5. Also total magnetic resistance of the magnetic circuit which is energized by the field coil 12 is expressed by r1+r2+r345+r6.

1/r345=1/(r3+r4)+1/r5 r345=r5(r3+r4)/(r3+r4+r5) (1)

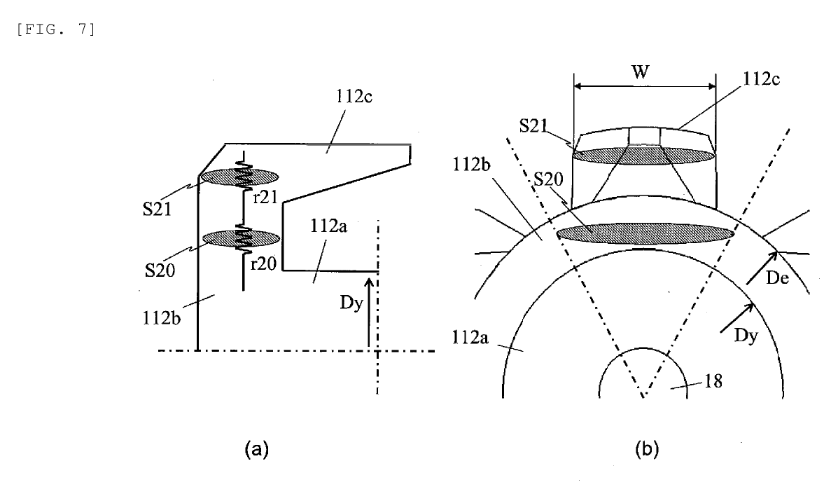

Here, it is considered that magnetic resistance r2 is formed of the series connection of magnetic resistance r20 and magnetic resistance r21 shown in FIG. 7. FIG. 7 is a view showing a connection portion between the endplate portion 112b and the claw portion 112c in detail. A magnetic path relating to one claw portion 112c is considered in association with a region sandwiched by chained lines in FIG. 7(b). It is also considered that there are two magnetic-path cross-sectional areas S20, S21 in the region sandwiched by the chained lines. Further, assume magnetic resistance of a portion represented by the magnetic path cross-sectional area S20 (that is, a portion inside a radius De/2) as r20, and magnetic resistance of a portion represented by the magnetic path cross-sectional area S21 (that is, a portion outside the radius De/2) as r21. Accordingly, magnetic resistance r2 in FIG. 5(a) is expressed by a following formula (2).

r2=r20+r21 (2)

The magnetic path cross-sectional areas S20, S21 are simply expressed by following formulae (3), (4). Symbol P indicates the number of poles, and symbol W indicates a width of the claw portion 112c as shown in FIG. 7(b). Symbol X2 indicates a thickness size of the end plate portion 112b as shown in FIG. 6.

S20=X2·(πDy/P/2+πDe/P/2)/2 (3)

S21=W·X2 (4)

In this embodiment, to enhance the efficiency of an alternator for a vehicle, a shape of the rundel-type rotor is studied by performing simulations by making use of a three-dimensional electromagnetic field analyzing technique. In this three-dimensional electromagnetic field analysis, adopted is an analyzing method where a set of alternator for a vehicle which includes the stator, the rundel-type rotor and an air layer around the stator and the rundel-type rotor is divided into minute blocks having a proper size (although the minute block is referred to as a minute space block constituted of a node and an element analytically, actually, one set of alternator for a vehicle is divided into several hundreds of thousands number of blocks) by taking into account the magnetic flux distribution and the magnetic flux density on respective portions, and the degree of magnetic saturation, magnetic permeability and magnetic flux density for every minute block are calculated and analyzed in accordance with a distribution constant.

To obtain an alternator for a vehicle having a large output current without changing a frame, it is important for the rotor 112 to generate a larger induction voltage by efficiently introducing a magnetic flux generated by the field coil 12 into a stator core side. In view of the above, in this embodiment, following measures (a) to (c) are taken.

(a) Optimization of a gap size between claw magnetic poles

(b) Improvement of a shape (outer peripheral surface shape) of the claw portion 112c

(c) Improvement of a side surface shape of the claw portion 112c

[a. Optimization of a Gap Size Between Claw Magnetic Poles]

In case of the rotor 112 as shown in FIG. 5, a magnetic flux enters the stator core 21 through the regions S40, S50 on the outer peripheral surface of the claw portion 112c. The plurality of claw portions 112c which are arranged in the circumferential direction take an N pole and an S pole alternately, and a magnetic flux which is emitted from the N-pole claw portion 112c enters the stator core 21 and, thereafter, returns to the claw portion 112c which is arranged adjacent to the N-pole claw portion 112c and takes an S pole. An effective magnetic flux which enters the stator core 21 from the claw portion 112c depends on areas of the regions S40, S50 of the claw portion 112c which faces the stator core 21 in an opposed manner, that is, a surface area of the claw magnetic pole.

On the other hand, when the gap size G between claw magnetic poles (see FIG. 2) is made small in an attempt to increase areas of the regions S40, S50, the influence of a leakage magnetic flux where a magnetic flux enters the neighboring claw portion 112c from the claw portion 112c is increased.

In general, the increase of the claw magnetic pole surface area increases an effective magnetic flux, while the increase of a leakage magnetic flux causes the decrease of the effective magnetic flux. The claw magnetic pole surface area depends on the gap size between claw magnetic poles unless a shape of an outer peripheral surface of the claw magnetic pole is changed. In this embodiment, a simulation calculation of an output current is performed using the gap size between claw magnetic poles as a parameter so as to obtain a gap size between claw magnetic poles where an output current becomes a peak value, that is, a gap size between claw magnetic poles where an effective magnetic flux becomes the maximum.

[b. Improvement of an Outer Peripheral Surface Shape of the Claw Portion 112c]

In this embodiment, the outer peripheral surface shape of the claw portion 112c is set such that a width size W (see FIG. 7(b)) of the claw portion 112c in the circumferential direction in cross section perpendicular to the extending direction of the claw portion 112c is gradually increased from a claw-portion distal end 1121 to an end-plate-side end portion 1120 in the claw-portion extending direction shown in FIG. 6(b). Accordingly, the outer peripheral surface shape of the claw portion 112c shown in a plan view in FIG. 6(b) has a trapezoidal shape. Due to such a shape, a larger effective magnetic flux enters the stator core 21 from the claw-magnetic-pole outer peripheral surface. In terms of magnetic resistance, the outer peripheral surface shape is set such that magnetic resistances r4, r5 are decreased.

[c. Improvement of Side Surface Shape of the Claw Portion 112c]

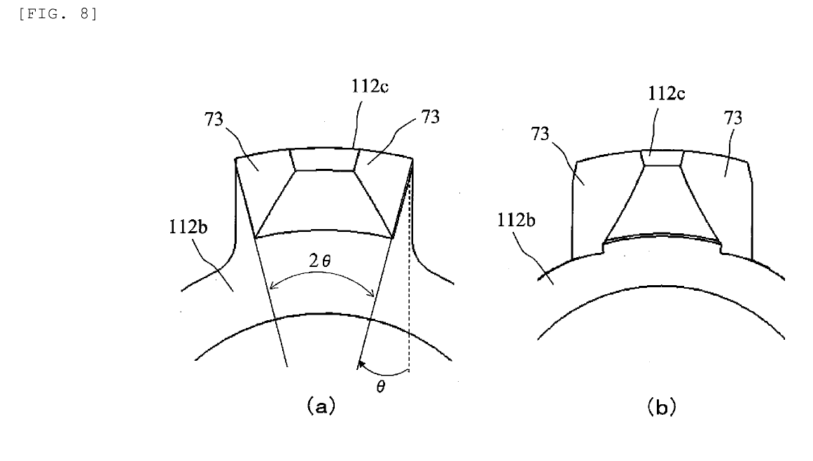

In the conventional rundel-type rotator, as shown in FIG. 8(a), each claw portion 112c has a shape where two side surfaces 73 which face neighboring claw portions 112c in an opposed manner respectively are made to come closer to each other from an outer diameter side to an inner diameter side. To compare with a case where an outer-diameter-side width and an inner-diameter-side width of the claw portion 112c are set equal (a case shown in FIG. 8 (b)), the respective side surfaces 73 are made to come closer to each other by an angle θ from side surface positions respectively so that an angle made by two side surfaces 73 becomes 2θ. For example, when the number of poles is 12, the side surfaces 73 of the claw portion 112c are made to come closer to each other by 15 degrees per each side, and when the number of poles is 16, the side surfaces 73 of the claw portion 112c are made to come closer to each other by 11.25 degrees per each side.

Due to such a shape, a gap size between the neighboring claw portions of the rotor 112, that is, a gap size between the claw portion 112c of the rotor core 112F and the claw portion 112c of the rotor core 112R is held at a fixed value from the outer diameter side to the inner diameter side. This structure is adopted so as to prevent a gap between the claw portions 112c from being decreased even at a position closer to the inner diameter side in an attempt to prevent the increase of a leakage magnetic flux between the claw portions 112c.

However, according to result which inventors of the present invention have acquired by analyzing an electromagnetic field, as shown in FIG. 8(b), it is found that, by abandoning the narrowing of the width of the claw portion 112c toward the inner diameter side (for example, 15 degrees per each side in case of the alternator having 12 poles), and by increasing a cross-sectional area of the claw portion 112c by making both the outer-diameter-side width size and the inner-diameter-side width size of the claw portion 112c equal to each other instead, it is possible to effectively increase an output current.

### (Simulation Result)

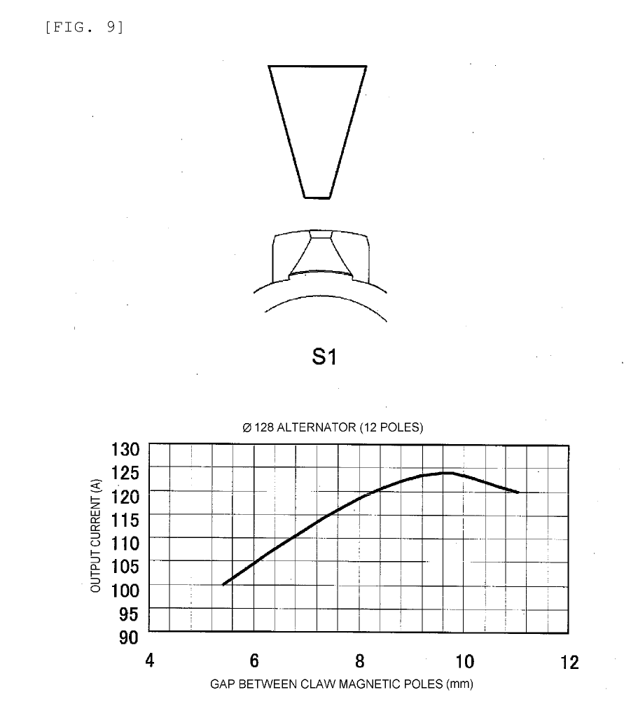

FIG. 9 and FIG. 11 to FIG. 14 show a result of the simulation calculation performed with respect to the above-mentioned three items (a) to (c). In general, although there are some exceptions, an alternator for a vehicle is substantially classified into two series which are nominally named as φ128 alternators and φ139 alternators. These nominal names are derived from an outer diameter of the stator core 21, wherein the outer diameter of the stator core of the φ128 alternator is set to approximately 128 mm, and the outer diameter of the stator core of the φ139 alternator is set to approximately 139 mm.

Firstly, the φ128 alternator is explained. Specific sizes of the rotor core are, by making use of representative design constants of the φ128 alternator manufactured conventionally, set such that the number of poles=12 poles, Dy=54 mm, Ds=17 mm, Dr=99.4 mm, and δ=0.3 mm. A thickness X2 of the end plate portion 112b is also set such that X2=13.5 mm in the same manner as a conventional alternator. Further, values of Ly, Ls in FIG. 5 are set such that Ly=26 mm and Ls=34 mm. Respective sizes of an alternator for a vehicle nominally named as the φ128 alternator are substantially equal to the above-mentioned respective sizes. Accordingly, provided that the alternator is an alternator for a vehicle which is nominally named as a φ128 alternator, the result substantially equal to the result of the simulation calculation described below can be obtained.

FIG. 9 shows a shape of the claw portion 112c of the rotor 112 according to this embodiment, that is, a shape of the claw portion 112c when the above-mentioned items [b. improvement of an outer peripheral surface shape of claw portion 112c] and [c. improvement of a side surface shape of the claw portion 112c] are taken into account, and a simulation result of such a case. The claw shape S1 shown in FIG. 9 has an outer peripheral surface shape shown in FIG. 6(b). Further, with respect to the claw side surface shape, as shown in FIG. 8(b), an inner-diameter-side width of the claw portion 112c and an outer-diameter-side width of the claw portion 112c are set equal. When a gap size G between claw magnetic poles is changed on the premise of such a shape, a simulation result (output current) shown in FIG. 9 is obtained.

The simulation result (output current) shown in FIG. 9 indicates an output current when the gap size G between claw magnetic poles is changed with respect to the claw shape S1. According to the calculation result, the output current is increased when the gap size G between claw magnetic poles is increased, and the output current exhibits a peak between G=9 mm and G=10 mm (in the vicinity of approximately 9.7 mm). When the gap size G between claw magnetic poles is set to a value larger than the peak position, the output current is decreased along with the increase of the gap size G between claw magnetic poles.

Such a characteristic may be considered as follows. In a region where the gap size between claw magnetic poles G is smaller than approximately 9.7 mm, when the gap size between claw magnetic poles G is increased, the increase of an effective magnetic flux due to the decrease of a leakage magnetic flux is larger than the decrease of the effective magnetic flux due to the decrease of a claw magnetic pole surface area and hence, an output current exhibits an increasing tendency. On the other hand, in a region where the gap size between claw magnetic poles G is larger than approximately 9.7 mm, the gap size between claw magnetic poles G is large and hence, the influence of the leakage magnetic flux becomes small. Accordingly, the influence brought about by the decrease of the claw magnetic pole surface area becomes dominant so that the effective magnetic flux is decreased leading to the decrease of the output current.

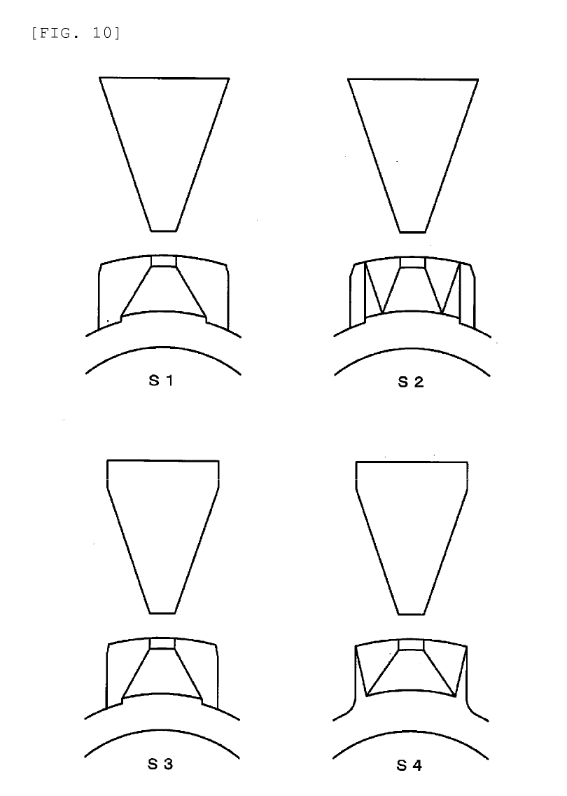

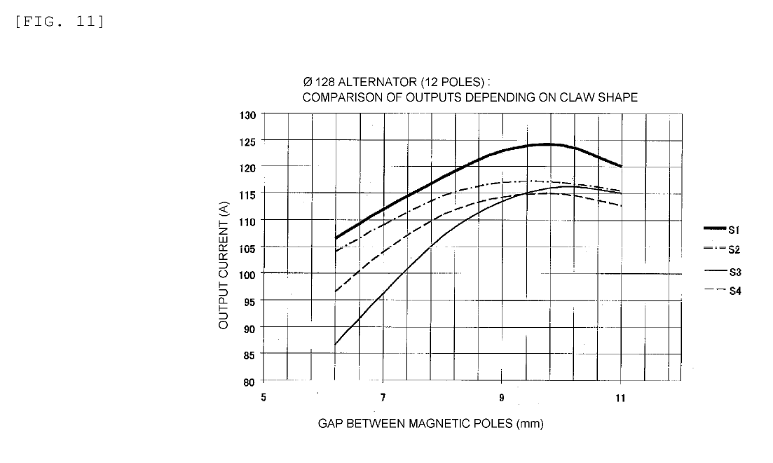

Further, the simulation of an output current is performed not only with respect to the case where the claw shape S1 shown in FIG. 9 is adopted as the shape of the claw portion 112c but also cases where claw shapes S2, S3, S4 shown in FIG. 10 are adopted as the shape of the claw portion 112c. FIG. 11 shows the simulation results of output currents with respect to the claw shapes S1, S2, S3, S4.

The claw shape S2 has a shape shown in FIG. 6(b) as an outer peripheral surface shape thereof, and has a shape where claw side surfaces of the claw portion 112c are made to come closer to each other toward an inner diameter side as shown in FIG. 8(a) as a claw-side surface shape thereof. The claw shape S3 has a shape shown in FIG. 6(a) as an outer peripheral surface shape thereof, and has a shape shown in FIG. 8(b) as a claw side surface shape thereof. The claw shape S4 is a conventional claw shape, and is formed by combining the outer peripheral surface shape shown in FIG. 6(a) and the claw side surface shape shown in FIG. 8(a).

As shown in FIG. 11, when the claw shape S2 is adopted, an output current is, as a whole, smaller than an output current when the claw shape S1 is adopted, and a peak position of an output current curve falls between G=9 mm and G=10 mm. As the reason why an output current is increased as a whole in the case where the narrowing of the width of the claw portion toward a claw inner diameter side is abandoned as in the case where the claw shape S1 is adopted compared to the case where the claw shape S2 which is provided with such narrowing is adopted, it is considered that the enhancement of the permeation of a magnetic flux (lowering of magnetic resistance r3) brought about by abandoning the narrowing surpasses a reduction effect of a leakage magnetic flux brought about by narrowing the width of the claw portion 112c toward a claw inner diameter side.

Further, although the peak position when the claw shape S2 is adopted is slightly shifted toward a left side compared to a case where the claw shape S1 is adopted, it is considered that such shifting is brought about by the increase of a gap on a claw inner diameter side due to narrowing of the width of the claw portion toward a claw inner diameter side so that the gap G between claw magnetic poles G on which the influence of a leakage magnetic flux is exerted is shifted toward a left side.

On the other hand, an output current curve when a claw shape S3 is adopted and an output current curve when the claw shape S4 is adopted intersect with each other between the gap size between claw magnetic poles G =9 mm and the gap size between claw magnetic poles G=10 mm. When the gap size between claw magnetic poles G is smaller than a value of the size G at an intersecting point, an output current when the claw shape S4 is adopted is larger than an output current when the claw shape S3 is adopted and, to the contrary, when gap size between claw magnetic poles G is larger than a value of the size G at an intersecting point, the output current when the claw shape S3 is adopted is larger than an output current when the claw shape S4 is adopted. Such a characteristic can be considered as follows.

That is, to compare the claw shape S3 and the claw shape S4 on a condition that the gap size G between claw magnetic poles is equal, the claw shape S3 has the same claw width size on an outer diameter side and an inner diameter side and hence, an actual gap size on an inner diameter side is set smaller than the gap size G between claw magnetic poles on an outer diameter side. Accordingly, the claw shape S3 exhibits a larger claw cross-sectional area and a larger leakage magnetic flux than the claw shape S4. That is, the claw shape S3 has a larger effective magnetic flux attributed to the claw cross-sectional area than the claw shape S4 by an amount corresponding to the difference in claw cross-sectional area and, to the contrary, the claw shape S3 has a smaller effective magnetic flux attributed to a leakage magnetic flux than the claw shape S4 by an amount corresponding to the difference in a leakage magnetic flux. Which one of an output current when the claw shape S3 is adopted and an output current when the claw shape S4 is adopted becomes larger is decided based on whether this differential (=the increase of the effective magnetic flux attributed to the difference in claw cross-sectional area)−(the decrease of the effective magnetic flux attributed to the difference in leakage magnetic flux)) is positive or negative.

In a region where the gap size between claw magnetic poles G is small, the influence of a leakage magnetic flux is large and hence, it is considered that the decrease of the effective magnetic flux attributed to the difference in a leakage magnetic flux becomes larger than the increase of an effective magnetic flux attributed to the difference in a claw cross-sectional area. That is, the difference becomes smaller than 0 and hence, an output current when the claw shape S4 is adopted becomes larger than an output current when the claw shape S3 is adopted. On the other hand, when the gap size G between claw magnetic poles is increased to some extent, the influence of the leakage magnetic flux becomes small and hence, it is considered that the increase of the effective magnetic flux attributed to the difference in the claw cross-sectional area becomes larger than the decrease of the effective magnetic flux due to the difference in a leakage magnetic flux. That is, the difference becomes larger than 0 and hence, an output current when the claw shape S3 is adopted becomes larger than an output current when the claw shape S4 is adopted. In a graph shown in FIG. 11, the difference becomes 0 at an intersecting point (in the vicinity of G=9.2 mm) and the difference becomes smaller than 0 in an area where the gap size between claw magnetic poles G is smaller than the intersecting point. To the contrary, the difference becomes larger than 0 in an area where the gap size G between claw magnetic poles is larger than the intersecting point.

Here, an output current when the claw shape S1 is adopted and an output current when the claw shape S2 is adopted (both claw shapes S1, S2 having a trapezoidal shape as an outer peripheral surface shape of the claw portion 112c) are compared to each other. In this case, the output current when the claw shape S1 is adopted where the claw side surfaces are not made to come closer to each other toward an inner diameter side is always larger than the output current when the claw shape S2 is adopted so that the reversal between the output currents which is brought about when the claw shapes S3, S4 are adopted shown in FIG. 11 does not occur. As shown in FIG. 2, FIG. 5 and FIG. 6, in the claw portion 112c having a trapezoidal shape, a claw magnetic pole surface area is increased by 2ΔS compared to a claw magnetic pole surface area of a claw portion having a conventional shape. Accordingly, the claw shapes S1, S2 have a larger claw magnetic pole surface area than the claw shapes S3, S4 so that the influence of a leakage magnetic flux exerted on an effective magnetic flux is further decreased. Further, since a cross-sectional area of the end plate portion is large, magnetic resistance is lowered thus eventually contributing to the increase of a magnetic flux amount and the increase of an effective magnetic flux. As a result, it is considered that when the claw portion 112c has a trapezoidal shape, the reversal of the output currents shown in FIG. 11 does not occur.

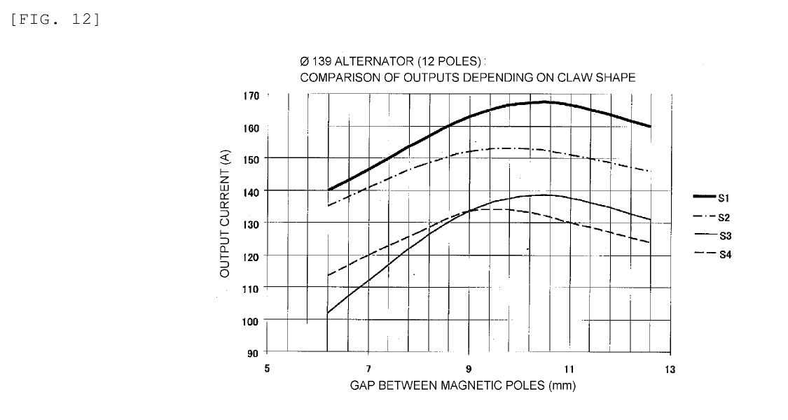

FIG. 12 shows a simulation result relating to the φ139 alternator. Also in case of the φ139 alternator, respective sizes of the rotor cores 112F, 112R are, by making use of representative design constants of the φ139 alternator manufactured conventionally, set such that the number of poles=12 poles, Dy=60 mm, Ds=17 mm, Dr=106.3 mm, and δ=0.35 mm. A thickness X2 of the end plate portion 112b is also set to X2=14.5 mm in the same manner as a conventional alternator. Further, values of Ly, Ls are set such that Ly=15 mm and Ls=34 mm. Respective sizes in an alternator for a vehicle nominally named as the φ139 alternator are substantially equal to the above-mentioned respective sizes. Accordingly, provided that an alternator is an alternator for a vehicle which is nominally named as a φ139 alternator, the result substantially equal to the result of the simulation calculation described below can be obtained.

An output current curve of the φ139 alternator also exhibits the substantially same tendency as the φ128 alternator. That is, an output current when the claw shape S1 is adopted is, as a whole, larger than an output current when the claw shape S2 is adopted, and an output current curve when the claw shape S3 is adopted and an output current curve when the claw shape S4 is adopted intersect with each other.

In both cases where the claw shapes S1, S2 are adopted, the peak position of an output current falls between G=9 mm and G=11 mm, while the gap size G between claw magnetic poles where an output current when the claw shape S2 is adopted becomes a peak value is smaller than a gap size G between claw magnetic poles where an output current when the claw shape S1 is adopted becomes a peak value. In this manner, also in case of φ139 alternator, when a shape of the outer peripheral surface of the claw portion 112c is a trapezoidal shape, the output current can be enhanced by abandoning the narrowing of the width of the claw portion 112c toward an inner diameter side.

Further, to compare the case where the claw shape S3 is adopted with the case where the claw shape S4 is adopted, the gap size G between claw magnetic poles at an intersecting point of the output current curves is approximately G=9 mm. When the gap size G between claw magnetic poles is smaller than G=9 mm, the output current when the claw shape S4 is adopted is larger than the output current when the claw shape S3 is adopted. To the contrary, when the gap size G between claw magnetic poles is larger than G at the intersecting point, the output current when the claw shape S3 is adopted is larger than the output current when the claw shape S4 is adopted.

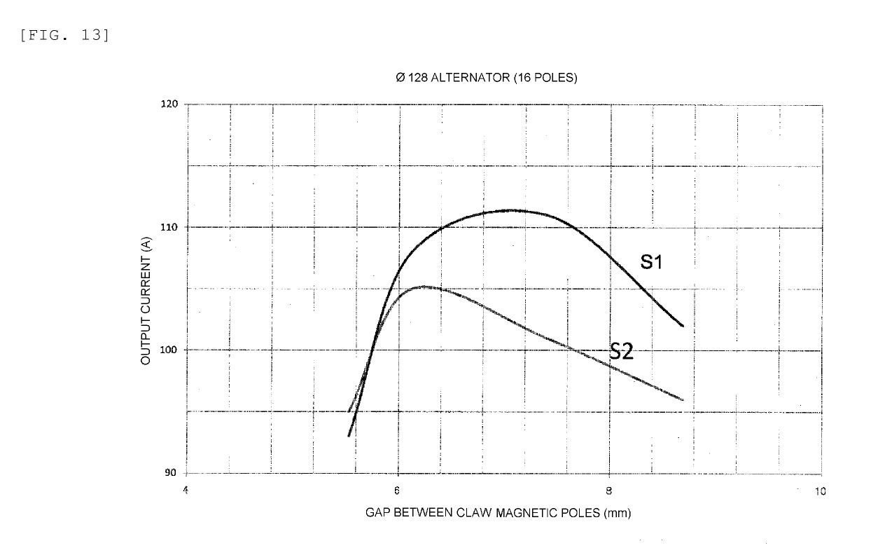

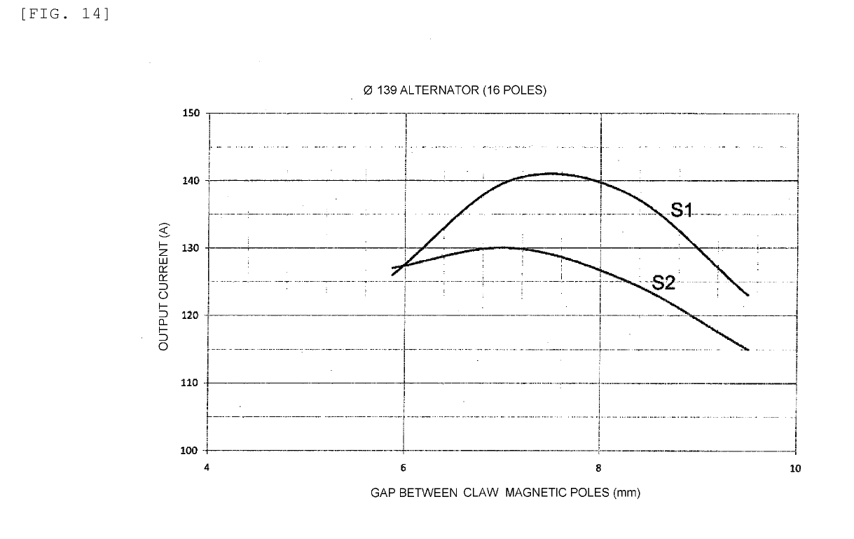

FIG. 13 shows a simulation result when the number of poles in the φ128 alternator is set to 16, and FIG. 14 shows a simulation result when the number of poles in the φ139 alternator is set to 16. In both cases, an output current when the claw shape S1 is adopted according to this embodiment and an output current when the claw shape S4 is adopted according to the prior art are indicated.

When the simulation results shown in FIG. 13 and FIG. 14 and the simulation results on the claw shapes S1, S4 of 12 poles shown in FIG. 11 and FIG. 12 are compared, these cases differ from each other with respect to a point that the relationship between the magnitudes of the output currents is reversed in an area where the gap size G between claw magnetic poles is small. 16 poles are larger than 12 poles in the number of poles and hence, when the same gap size G between claw magnetic poles is set, a width size of the claw portion 112c when the number of poles is 12 is smaller than a width size of the claw portion 112c when the number of poles is 16. Accordingly, the influence of a leakage magnetic flux in an area where the gap size G between claw magnetic poles is small is larger in the case where the number of poles is 16 than the case where the number of poles is 12. Further, claw side surfaces are not made to come closer to each other toward an inner diameter side when the claw shape S1 is adopted and hence, the influence of a leakage magnetic flux is more liable to be exerted compared to the case where the claw shape S4 is adopted. As a result, as shown in FIG. 11 and FIG. 12, the reversal of the output currents occurs in area where a gap G between claw magnetic poles is small.

As described above, with respect to the enhancement of an effective magnetic flux in the alternator for a vehicle provided with the rundel-type rotor, the magnitude of a leakage magnetic flux generated by the adjustment of the gap size between claw magnetic poles and the magnitude of the claw magnetic pole surface area have the trade-off relationship. Accordingly, in this embodiment, by carrying out the simulation calculation explained in detail with respect to the output current when the gap size between claw magnetic poles is changed, it is possible to set the gap size between claw magnetic poles between the first claw portion and the second claw portion arranged adjacent to each other to a value which falls within a predetermined optimum gap range including the gap size between claw magnetic poles at which the output current becomes maximum. To summarize the above-mentioned simulation results, the following is obtained.

### (Gap Size Between Claw Magnetic Poles)

When only the gap size G between claw magnetic poles is changed to various values without changing the shape of the claw portion 112c, there is a size where an output current value becomes a peak value. To classify optimum ranges of the output current, the optimum range is a range from 8 mm or more to 11 mm or less in case of the φ128 alternator having 12 poles, and the optimum range becomes a range from 8 mm or more to 12 mm or less in case of the φ139 alternator having 12 poles. Further, when the number of poles is 16, the optimum range of the output current becomes a range from 6 mm or more to 8 mm or less in case of the φ128 alternator, and becomes a range from 6 mm or more to 9 mm or less in case of the φ139 alternator. By setting the gap size G between claw magnetic poles in this manner, the output current can be enhanced even when any one of the claw shapes S1 to S4 is adopted.

(Outer Peripheral Surface Shape of the Claw Portion 112c)

In this embodiment, two shapes shown in FIGS. 6(a) and FIG. 6(b) have been studied as the outer peripheral surface shape of the claw portion 112c. By comparing the claw shape S1 and the claw shape S3 and by comparing the claw shape S2 and the claw shape S4 with respect to the output current, it is found that the larger output current can be obtained by adopting the outer peripheral surface shape shown in FIG. 6(b).

With respect to the case where the side surface shapes of the claw portion 112c are set to a shape where a width size is equal between an inner diameter side and an outer diameter side as shown in FIG. 8(b), the output current when the claw shape S1 shown in FIG. 11 and FIG. 12 is adopted and the output current when the claw shape S3 shown in FIG. 11 and FIG. 12 is adopted are compared to each other. Both in case of the φ128 alternator shown in FIG. 11 and in case of the φ139 alternator shown in FIG. 12, the case where the claw shape S1 (trapezoidal shape) is adopted exhibits a larger output current than the case where the claw shape S3 (conventional shape) is adopted. Although an increase amount of the output current differs slightly corresponding to the gap size G between claw magnetic poles, the increase amount of the output current is approximately 7 A to 20 A in case of the φ128 alternator, and is approximately 30 A to 40 A in case of the φ139 alternator.

Further, in the case where the side surface shape of the claw portion 112c is formed into a shape where the side surfaces are made to come closer to each other as shown in FIG. 8(a), the output current shown in FIG. 11 when the claw shape S2 is adopted and the output current shown in FIG. 12 when the claw shape S4 is adopted are compared to each other. Also in the case where the side surface shape of the claw portion 112c is formed into a shape where the side surfaces are made to come closer to each other, the case where the claw shape S2 having a trapezoidal shape is adopted exhibits a larger output current than the case where the claw shape S4 which is a conventional shape is adopted. Although an increase amount of the output current differs slightly corresponding to the gap size G between claw magnetic poles, the increase amount of the output current is approximately 3 A to 8 A in case of the φ128 alternator, and is approximately 20 A in case of the φ139 alternator.

Although the description of the output current relating to the claw shapes S2, S3 is omitted with respect to the case where the number of magnetic poles is 16, the relationship of the output current between the claw shape S1 and the claw shape S3 and the relationship of the output current between the claw shape S2 and the claw shape S4 in case where the number of magnetic poles is 16 are substantially equal to the corresponding relationships of the output current in case where the number of poles is 12.

In this manner, with respect to the outer peripheral surface shape of the claw portion 112c, the output current can be enhanced by adopting the trapezoidal shape irrelevant to whether or not the side surface shape of the claw portion 112c are formed into a shape where the side surfaces are made to come closer to each other. In other words, it is desirable to increase a width size of the claw portion 112c in the circumferential direction on a cross section perpendicular to the extending direction of the claw portion 112c such that the outer peripheral surface shape of the claw portion 112c has a trapezoidal shape ranging from the distal end to the end-plate-side end portion of the claw portion in the claw portion extending direction thus increasing a surface area of an outer peripheral surface of a claw root portion.

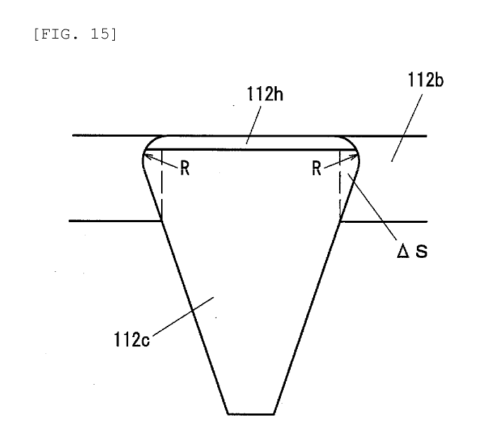

The purpose of forming the outer peripheral surface shape of the claw portion 112c into a trapezoidal shape lies in the improvement of an output current by increasing the surface area of the outer peripheral surface which is a surface through which a magnetic flux permeates, and a trapezoidal shape is a desirable shape when easiness of working or the like is taken into account. However, the shape may be deformed within a category of a trapezoidal shape. For example, a case where rounding is applied to the outer peripheral surface shape also falls within the category of the trapezoidal shape as shown in FIG. 15. Also in this case, it is desirable to form at least a stator core opposing surface area into a trapezoidal shape.

(Side Surface Shape of Claw Portion 112c)

To summarize the relationship between the side surface shape of the claw portion 112c and the output current, that is, the relationship between the presence and the non-presence of the narrowed shape and the output current, they are as follows. In this case, as shown in FIG. 11 and FIG. 12, the relationship between the magnitudes of the output currents differs depending on whether the outer peripheral surface shape of the claw portion 112c is a trapezoidal shape (claw shape S1, S2) or a conventional shape (claw shape S3, S4).

Firstly, an output current when the claw shape S1 is adopted and an output current when the claw shape S2 is adopted (both claw shapes S1, S2 having a trapezoidal shape as an outer peripheral surface shape of the claw portion 112c) are compared to each other. In both cases of the φ128 alternator and the φ139 alternator, irrespective of a value of the gap size G between claw magnetic poles, the output current when the claw shape S1 is adopted is larger than the output current when the claw shape S2 is adopted. That is, an output current is larger when the narrowed shape is not adopted.

On the other hand, output currents of the claw shape S3 and the claw shape S4 having a conventional shape as an outer peripheral surface shape of the claw portion 112c are compared to each other. In both cases of the φ128 alternator and the φ139 alternator, it is understood that the relationship between the magnitudes of the output currents is reversed. In case of the φ128 alternator shown in FIG. 11, output current curves intersect each other between G=9.2 mm and G=9.4 mm, and the output current when the claw shape S4 having a narrowed shape is adopted is larger in a region where the gap size G between claw magnetic poles is smaller than an intersecting position, while the output current when the claw shape S3 not having a narrowed shape is adopted is larger in a region where the gap size G between claw magnetic poles is larger than the intersecting position. Further, in case of the φ139 alternator shown in FIG. 12, output current curves intersect with each other at a position where G=approximately 9 mm, and the output current when the claw shape S4 having a narrowed shape is adopted is larger in a region where the gap size G between claw magnetic poles is smaller than an intersecting position, while the output current when the claw shape S3 not having a narrowed shape is adopted is larger in a region where the gap size G between claw magnetic poles is larger than the intersecting position.

When all of the gap size G between claw magnetic poles, the outer peripheral surface shape of the claw portion 112c, and the side surface shape of the claw portion 112c described above are taken into consideration, in both cases of the φ128 alternator (12 poles) and the φ139 alternator (12 poles), it is preferable that a claw shape is set to the claw shape S1 shown in FIG. 11 and a gap size between claw magnetic poles is set to a value which falls within a range from 8 mm or more to 11 mm or less. Due to such a constitution, an output of the alternator for a vehicle can be further enhanced.

The above-mentioned respective embodiments may be used in a single form or in combination. This is because the advantageous effects of the respective embodiments can be acquired individually or synergistically. The present invention is not limited to the above-mentioned embodiments unless the characteristic of the present invention is impaired.

### REFERENCE SIGNS LIST

4: stator, 5: stator winding, 11: rectifying circuit, 12: field coil, 21: stator core, 100: alternator for a vehicle, 112: rotor, 112a: cylindrical portion, 112b: end plate portion, 112c: claw portion, 112F, 112R: rotor core, G: gap size between claw magnetic poles

1. An alternator for a vehicle comprising:
a rundel-type rotor which includes a cylindrical portion around which a field coil is wound, first and second plate-shaped end plate portions which are arranged such that the end plate portions face both end surfaces of the cylindrical portion in the axial direction in an opposed manner, a plurality of first claw portions which extend parallel to a rotary axis in the direction from the first end plate portion to the second end plate portion, and a plurality of second claw portions which extend parallel to the rotary axis in the direction from the second end plate portion to the first end plate portion, and are arranged alternately in the circumferential direction with respect to the plurality of first claw portions; and
a stator which is arranged on an outer peripheral side of the rundel-type rotor with a rotary gap therebetween so as to face the rundel-type rotor in an opposed manner, and has a laminated core on which an armature coil is wound,
a size of a gap between a claw magnetic pole of the first claw portion and a claw magnetic pole of the second claw portion which are arranged adjacent to each other is set to a value which falls within a predetermined optimum gap range including a size of the gap between the claw magnetic poles where an output current becomes maximum.

2. The alternator for a vehicle according to claim 1, wherein the alternator for a vehicle is a nominal φ128 alternator for a vehicle provided with the rundel-type rotor having 12 poles, and
the optimum gap range is set to a range from 8 mm or more to 11 mm or less.

3. The alternator for a vehicle according to claim 1, wherein
the alternator for a vehicle is a nominal φ139 alternator for a vehicle provided with the rundel-type rotor having 12 poles, and
the optimum gap range is set to a range from 8 mm or more to 12 mm or less.

4. The alternator for a vehicle according to claim 1, wherein
the alternator for a vehicle is a nominal φ128 alternator for a vehicle provided with the rundel-type rotor having 16 poles, and
the optimum gap range is set to a range from 6 mm or more to 8 mm or less.

5. The alternator for a vehicle according to claim 1, wherein
the alternator for a vehicle is a nominal φ139 alternator for a vehicle provided with the rundel-type rotor having 16 poles, and
the optimum gap range is set to a range from 6 mm or more to 9 mm or less.

6. The alternator for a vehicle according to claim 1, wherein
a width size of the claw portion in the circumferential direction on a cross section perpendicular to the extending direction of the claw portion is set to increase from a distal end of the claw portion to an end-plate-side end portion of the claw portion in the claw portion extending direction such that an outer peripheral surface shape of the first claw portion and an outer peripheral surface shape of the second claw portion which face the stator have a trapezoidal shape respectively.

7. The alternator for a vehicle according to claim 6, wherein
the first and second claw portions have the same width size of the claw portion in the circumferential direction on the cross section perpendicular to the extending direction of the claw portion from an outer diameter side to an inner diameter side of the claw portion.
